(19) United States
(12) Patent Application Publication
(10) Pub. No.: US 2011/0270743 A1
(43) Pub. Date: Nov. 3, 2011

(54) FINANCIAL TRANSACTION SYSTEMS

(75) Inventors: Jeremy Laight, London Greater London (GB); Michael Wedderspoon, London Greater London (GB); Alex Topham, Edinburgh (GB)

(73) Assignee: THE ROYAL BANK OF SCOTLAND, Edinburgh (GB)

(21) Appl. No.: 13/062,656

(22) PCT Filed: Sep. 7, 2009
(86) PCT No.: PCT/EP2009/061536

§ 371 Date: Jun. 16, 2011

(30) Foreign Application Priority Data
Sep. 8, 2008 (GB) 0816380.0

(51) Int. Cl. G06Q 40/00

(52) U.S. Cl. 705/39

(57) ABSTRACT

Embodiments of the present invention disclose a financial transaction system comprising a report processor (133) to determine one or more characteristics of transaction activity over a first time period of at least a first account; and, a service processor (131) to adjust one or more growth parameters of at least a second account on the basis of said determined one or more characteristics.

### FIELD OF THE INVENTION

The present invention relates to transaction systems and, particularly, but not exclusively, to systems and methods for linking two or more financial transaction accounts.

### BACKGROUND OF THE INVENTION

Financial transaction systems and infrastructures are widespread and well known. Such systems are commonly referred to as banking systems, although financial institutions other than banks (for example, building societies, credit card issuers, co-operatives, e-money institutions, credit unions etc.) operate and use such systems and infrastructures. Accordingly, the terms ‘bank’ and ‘banking’ are used herein in a non-limiting way to encompass all kinds of institutions which offer financial services and use and/or operate such systems and infrastructures.

Bank accounts are generally opened by legal entities (‘account holders’), such as individuals, companies or other organisations. Typically, accounts are used to hold funds and can receive credits or satisfy debits as long as sufficient funds (or credit facilities) are available. There are many kinds of bank account, for example cash accounts, checking accounts, credit card accounts, deposit accounts, current accounts, offset accounts, mortgage accounts, savings accounts etc., and the present invention is in no way limited to any particular kind of account.

Banking systems and infrastructures frequently handle inter-account fund transfers or payments, which can be credits or debits depending on the direction in which the funds are flowing in relation to originating and destination accounts. Such transfers or payments will be referred to generally herein as ‘transactions’. Account holders can effect transactions in a number of ways including, but not limited to, credit card purchases, account transfers, ATM withdrawals (or deposits) and cheque deposits. For example, an account holder may transfer funds from a current account to a credit card account to settle an outstanding credit balance. Furthermore, transactions can be carried out automatically using systems such as automated direct debit. These methods and systems are well known.

Often an account is associated with an interest rate which is payable to the account holder by the financial institution on positive account balances. For example, a typical savings account may be associated with an annual interest rate of 5% which may accrue daily, monthly or yearly. The interest rate is determined by the financial institution with which the account is held, and can be changed in response to general economic or commercial factors.

Conversely, accounts such as credit card accounts typically allow the account holder to borrow money from the financial institution, but, typically, an interest charge is levied on the account holder for outstanding balances at the end of a predefined period of typically one month.

Aside from offering competing interest rates, it is known to provide other benefits to increase loyalty to certain banks, bank accounts or credit cards. For example, certain credit cards award a card-holder with AirMiles™ or other kinds of incentive ‘points’, each time the card is used to purchase a certain value of goods or services. The AirMiles accrue in a separate AirMiles account. It is also known to round up the value of a transaction, for example made using a credit card, and deposit the difference between the actual transaction value and the rounded up value into a savings account (for example, see European Patent EP1915731). In essence, a savings deposit amount (i.e. the rounded up value) is deposited into the nominated savings account using a traditional credit transaction.

### SUMMARY OF THE INVENTION

In accordance with one aspect of the present invention, there is provided a transaction system comprising:

a report processor to determine one or more characteristics of transaction activity over a first time period of at least a first account; and,

a service processor to adjust one or more growth parameters of at least a second account on the basis of said determined one or more characteristics.

While the terms “growth parameter” is used herein and typically implies positive growth, it will be appreciated that growth may also be negative and, unless the contrary is indicated or otherwise implied, the term growth should be construed to encompass both positive and negative connotations.

The term “processor” as used herein includes but is not limited to hardware, firmware, software and/or combinations thereof to perform a function(s) or an action(s). A person skilled in the art will appreciate that where a single processor is described in the description, it will be possible in some embodiments of the present invention to distribute said single processor between multiple processors. Similarly, where multiple processors are described, it will be possible in some embodiments of the present invention to incorporate said multiple processors into a single processor.

In accordance with a second aspect, the present invention provides a transaction method comprising:

determining one or more characteristics of transaction activity over a first time period of at least a first account;

adjusting one or more growth parameters associated with at least a second account on the basis of said determined one or more characteristics; and,

applying said adjusted one or more growth parameters to funds in said at least a second account over a second time period.

According to aspects and embodiments of the present invention, and unless the context dictates otherwise, ‘system’ as used herein may encompass an individual bank's system and infrastructure, or a broader banking (e.g. inter-banking) infrastructure.

Further features and advantages of the invention will become apparent from the following description of preferred embodiments of the invention, given by way of example only, which is made with reference to the accompanying drawings.

### BRIEF DESCRIPTION OF THE DRAWINGS

The accompanying drawings illustrate various example systems, methods and other example embodiments of various aspects of the invention. It will be appreciated that the illustrated element boundaries (e.g., boxes, groups of boxes, or other shapes) in the figures represent one example of the functional boundaries. A person skilled in the art will be appreciate that unless otherwise stated one element may be designed as multiple elements, multiple elements maybe designed as one element, an element shown as an internal component of another element may be implemented as an external component and vice versa, and so on. Furthermore, elements may not be drawn to scale.

Embodiments of the present invention will now be described, by way of example only, with reference to the accompanying drawings, of which:

FIG. 1 is a schematic representation a system for linking transaction activity of a first account with one or more growth parameters of a second account in accordance with an embodiment of the present invention.

FIG. 2 is a flow diagram illustrating a method of linking transaction activity of a first account with one or more growth parameters of a second account in accordance with an embodiment of the present invention.

### DETAILED DESCRIPTION OF THE INVENTION

An exemplary embodiment of the present invention relates to a computer-implemented system for linking transaction activity on a first account with the interest rate of a second account. The first account is a credit card account and the second account is a savings account, but it will be understood that the present invention is not limited to such account types and may encompass cash accounts, checking accounts, deposit accounts, current accounts, offset accounts, mortgage accounts etc.

Systems for effecting transactions associated with a savings account typically comprise a savings account database containing records relating to a plurality of savings accounts held by a financial institution. Information held by the savings account database includes, for example, account balance, transaction history and account holder details. Transactions associated with the savings accounts in the savings account database are typically updated by a transaction processor or process, which can access the account data to append transaction data and update account balances. An interest processor or process calculates interest on the savings accounts based on a pre-determined but typically variable interest rate.

Systems for effecting transactions associated with a credit card account typically comprise a credit card database containing records relating to a plurality of credit card accounts. Information held by the credit card database includes, for example, debit balance, transaction history and account holder details. Transactions associated with the credit card accounts in the credit card database are updated by a transaction processor or process, which handles credit card transactions originating from an acquiring financial institution. Typically, payments to a credit card account by an account holder, in order to settle a debt on the account, are handled by a payment processor or process.

In practice, bank transaction systems are typically provided by powerful mainframe computers, for example, operating under CICS Transaction Server software, which is a provided by IBM™. The details of such systems are well-known in the industry and are not described in further detail herein.

It is not uncommon for a person to hold both a credit card account and a savings account, and often (but not necessarily) these accounts are held by the same institution. It is known that accounts can be associated with one another such that, for example, a credit card balance can be paid-off automatically from a savings account. Such transactions are handled using established methods such as by setting up an automated direct debit transfer or similar. However, these methods are limited to simple credit/debit transactions.

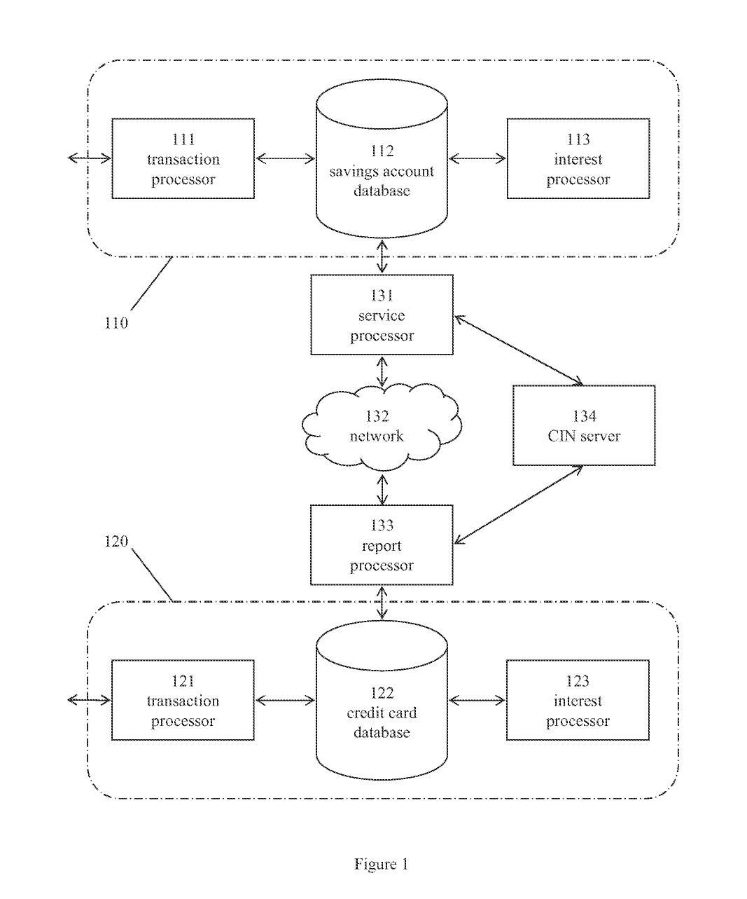

A system according to an exemplary embodiment of the present invention is illustrated schematically in FIG. 1. The system in FIG. 1 includes a savings account system 110 and a credit card account system 120, each being of generally known kind. However, the system includes in addition a report processor 133 and a service processor 131, which provide a link between the savings account system 110 and the credit card account system 120. As will be described, the system may include a customer identity number (CIN) server 134. The report processor 133 is operably connected to a credit card database 122 and can communicate with the service processor 131 via a network 132. The service processor 131 is operably connected to the savings account database 112.

The savings account database 112 is connected to a transaction processor 111 and an interest processor 113. The transaction processor 111 effects credit and debit transactions to the relevant accounts in the savings account database 112 and the interest processor 113 calculates and adds interest to accounts in the savings account database 112 at predefined intervals. Similarly, the credit card account database 122 is connected to a transaction processor 121 and an interest processor 123. The transaction processor 121 effects credit and debit transactions to the relevant accounts in the credit card account database 122 and the interest processor 123 calculates and deducts interest from accounts in the credit card database 122 at predefined intervals.

The report processor 133 continuously or periodically queries the credit card database 122 and receives data associated with one or more transactions made on a first account, analyses said data and determines one or more characteristics of the data. For embodiments where the first account is a credit card account, the associated transactions will generally comprise credit card transactions associated with retail purchases and cash advances. The report processor 133 analyses the received transaction data and determines which transactions are qualifying transactions according to predefined rules. In an exemplary embodiment of the present invention, qualifying transactions may include credit transactions but exclude cash advances, for example due to ATM withdrawals. In other embodiments, qualifying transactions may comprise: all transactions; different classifications of transactions (for example, differentiating between food and clothing); and even balance transfers (that is, when part of or an entire negative balance from one account is settled by a first account herein, which then shows the negative balance). The stages of receiving and analysing transaction data may be performed continuously or periodically at predefined time intervals, including but not limited to hourly, daily, weekly, monthly and quarterly. Alternatively, the period may not be fixed but, rather, determined according to when transaction values reach one or more predetermined threshold values. In this latter case, the system would include suitable threshold triggers.

The report processor 133 further determines one or more characteristics of the qualifying transactions over a predefined time period. In the exemplary embodiment of the invention, the time period is ninety days, but it should be understood that the present invention is not limited to any particular choice of time period. The determined characteristics can include the average monthly value of qualifying transactions made to the credit account. For example, the credit transactions over a ninety day period are summed and a monthly average value is calculated. The report processor 133 is configured to transmit the determined characteristics to the service processor 131 over a network 132. In some embodiments of the present invention, service processor 131 and report processor 133 may be geographically separate and connected via network 132. Alternatively, the service processor 131 and report processor 133 may be combined to provide a single service/report processor performing both functions. In such configurations the network 132 would not be required. In yet other embodiments, the functions of the service processor 131, the report processor 133 and, if present, the CIN server 134, may be embodied as additional functionality built into existing known savings account systems and credit card account systems.

In the exemplary embodiment, the service processor 131 is adapted to receive the characteristic data, and, according to predefined rules, adjust growth parameters of a linked savings account contained in the database 112 on the basis of said received characteristic data. More particularly, the service processor 131 is configured to adjust an interest rate associated with the linked savings account. The interest rate in this example comprises a base interest rate and a bonus interest rate, and growth parameters specifying the base interest rate and bonus interest rate are stored with the relevant accounts in database 112. It should be noted that whilst the base interest rate may be standard for a plurality of accounts, the bonus interest rate is assigned to each savings account individually. In the exemplary embodiment, the base interest rate is prescribed by the holding financial institution, and the bonus interest rate is determined by the service processor 131, based on the average monthly value of qualifying transactions made to the linked credit account over the predefined time period, but it is to be understood that the scope of the present invention is intended to encompass any bonus interest rate determined as a function of one or more characteristics of the two linked accounts. For example, the bonus interest rate may be increased due to the value of the qualifying transactions but the size of the increment may also be influenced by the level of funds in the savings account (e.g. the increment may be larger for lower levels of funds).

In the exemplary embodiment, the bonus interest rate is tiered according to the average monthly value of qualifying transactions on the linked credit card account. For example: if the base interest rate is 5% and the average monthly value of qualifying transaction is less than £250 the bonus interest rate is 0% and the combined interest rate is 5%; whereas, if the base interest rate is 5% and the average monthly value of qualifying transactions is greater than or equal to £250 then the bonus interest rate is 2% and the combined interest rate is 7%. Embodiments of the invention are not limited to use of a tiered bonus interest rate, and it is intended to encompass a wide range of alternative methods where growth parameters of the savings account are determined as a function of characteristics of the credit card account and/or savings account. For example, alternative embodiments of the present invention may calculate the bonus interest rate to be proportional to the average monthly value of qualifying transactions using a predefined coefficient. Many other options are available.

After determination of the bonus interest rate, the service processor 131 updates the relevant growth parameter(s) in the appropriate account record stored in the savings account database 112. The updated growth parameters are accessible by the interest processor 113 for calculation of an interest amount payable on the linked savings account. The interest processor 113 continuously or periodically calculates the interest payable to savings accounts stored in savings account database 112 according to the base interest rate and bonus interest rate stored for each account in database 112. The interest processor 113 periodically credits the accrued interest to the savings account at predefined intervals which may typically be daily, monthly, quarterly or yearly. In the exemplary embodiment, the updated bonus interest rate is applied by the interest processor for the 90 days after the updating of the growth parameters. In effect, the bonus interest rate is calculated on the basis of the value of the previous 90 days' credit card transactions and applied to the deposit account for the following 90 days. However, alternative embodiments may apply the bonus interest rate for a longer or shorter time period, or retrospectively backdate the interest calculation to a previous time period using historical account and transaction data. Alternatively, subsequent bonus interest rates may accumulate rather than replace former ones, for example, up to a pre-determined threshold and for a specified further period.

In the exemplary embodiment the linked accounts will typically be provided by a single financial institution and linking between the accounts is provided by a single CIN, which is common to both accounts. In practice, a CIN may be applied to or associated with every product or service provided by a bank to an account holder, and it is quite likely that a single product (for example a joint account) may have associated with it more than one CIN. By means of a CIN, characteristic data for a credit card account in the credit card account database 122 can be associated with a savings account in the savings account database 112. In a further embodiment, the credit card account and savings account may be held by different account holders and/or be provided by separate institutions. For example, an account held by person A may be linked with account held by person B and provided by the same financial institution. In any case, according to the exemplary embodiment, the CIN server 134 may be utilised to provide mapping and/or association of account identification information between the two accounts in any appropriate way. In some embodiments, the CIN mapping functionality will be incorporated into either the report processor, service processor or both. In such embodiments, a separate CIN processor is not necessary. Indeed, CIN server functionality can comprise any suitable way of associating one account with another.

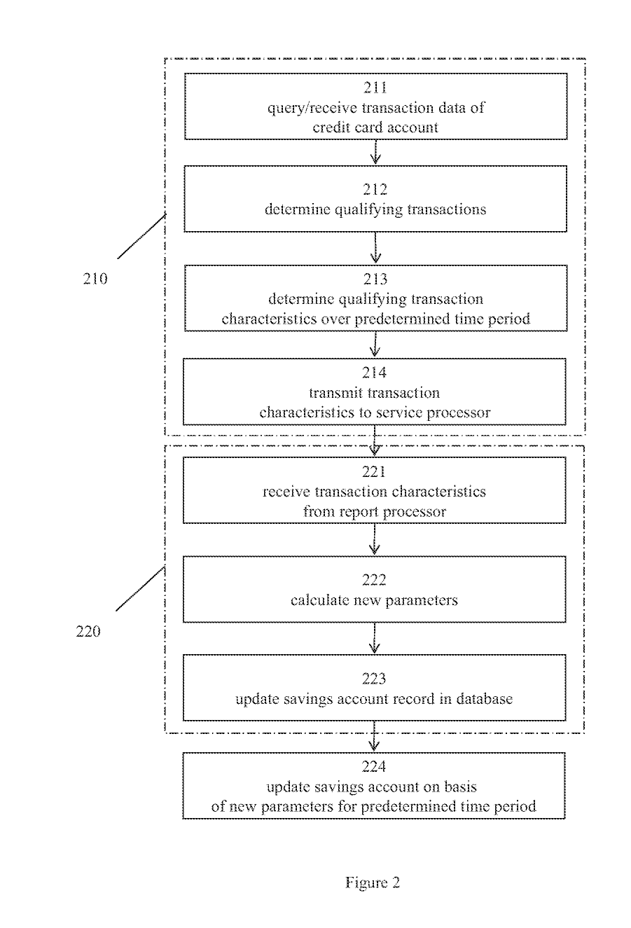

An exemplary embodiment of the present invention will now be described with reference to the flow diagram in FIG. 2. In the exemplary embodiment, steps 211-214 of the method are performed by the report processor 210, and steps 221-223 are performed by the service processor 220. However, a person skilled in the art will understand that all steps of the method may be performed by one or a plurality of processors or processes in various configurations without departing from the spirit and intended scope of the invention. In step 211 transaction data of a credit card account is received and/or queried from the credit card database. The transaction data is analysed and qualifying transactions are determined in stage 212. Next, characteristics of the qualifying transactions are determined 213 and the characteristics are transmitted to the service processor 214. The transaction characteristics are received by the service processor 221, and new growth parameters are determined 222 and updated in the savings account database 223. Finally the savings account interest is calculated on the basis of the updated growth parameters and credited to the relevant savings account 224.

Stages 211-213 are performed either continuously or periodically or using a combination of both. In the preferred embodiment the qualifying transaction characteristics comprise a monthly average of credit transactions made over a 90 period and stages 211-214 are performed periodically on a 90 basis. In an alternative embodiment, stages 211 and 212 may be performed continuously and stages 213 and 214 may be performed at the end of the predefined time period. In the exemplary embodiment, stage 224 is performed over a predefined time period of 90 days subsequent to the time period of stage 213. In alternative embodiments stage 224 may be applied retrospectively to backdate the interest calculation using historical account and transaction data.

The above embodiments are to be understood as illustrative examples of the invention and further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A transaction system comprising:
a report processor to determine one or more characteristics of transaction activity over a first time period of at least a first account; and,
a service processor to adjust one or more growth parameters of at least a second account on the basis of said determined one or more characteristics.

2. A system according to claim 1, comprising means to associate the first account(s) with the respective second account(s).

3. A system according claim 1, wherein the report processor is arranged to identify qualifying transactions in the transaction activity and determine the one or more characteristics based only on the qualifying transactions.

4. A system according to claim 3, wherein qualifying transactions comprise credit transactions.

5. A system according to claim 1, wherein the growth parameters are applied to funds in the second account(s) during a second time period.

6. A system according to claim 5, wherein the second period of time is the same as or overlaps with the first period of time.

7. A system according to claim 5, wherein the second period of time follows the first period of time.

8. A system according to claim 1, comprising an interest processor to apply said adjusted growth parameters, comprising an interest rate, to said at least a second account.

9. A system according to claim 8, wherein said interest rate comprises a base interest rate and a bonus interest rate, wherein only said bonus interest rate is determined on the basis of said determined one or more characteristics.

10. A system according to claim 1, wherein said at least a first account is a credit card account.

11. A method according to claim 1, wherein said at least a second account is a savings account.

12. A transaction method comprising:
determining one or more characteristics of transaction activity over a first time period of at least a first account;
adjusting one or more growth parameters associated with at least a second account on the basis of said determined one or more characteristics; and,
applying said adjusted one or more growth parameters to funds in said at least a second account over a second time period.

13. A method according to claim 12, comprising associating said first account(s) with said second account(s).

14. A method according to claim 12, comprising identifying qualifying transactions in the transaction activity and determining the one or more characteristics based only on the qualifying transactions.

15. A method according to claim 14, wherein said plurality of qualifying transactions comprise one or more credit transactions.

16. A method according to claim 12, wherein the growth parameters are applied to funds in the second account(s) during a second time period.

17. A method according to claim 16, wherein the second period of time is the same as or overlaps with the first period of time.

18. A method according to claim 16, wherein the second period of time follows the first period of time.

19. A method according to claim 12, wherein the said adjusted growth parameters comprise an interest rate, to be applied to said at least a second account.

20. A method according to claim 19, wherein said interest rate comprises a base interest rate and a bonus interest rate, wherein only said bonus interest rate is determined on the basis of said determined one or more characteristics.

21. A method according to claim 20, wherein said bonus interest rate is tiered according to a value of respective transactions on said at least a first account.
